(19) United States
(12) Patent Application Publication
(10) Pub. No.: US 2015/0210107 A1
(43) Pub. Date: Jul. 30, 2015

(54) SECURE IDENTIFICATION DOCUMENT WITH ABLATED FOIL ELEMENT

(71) Applicants: Nicholas Oliver Nugent, Hampshire (GB); Dennis James Warwick, Richfield, MN (US); Brian Beech, Bloomington, MN (US)

(72) Inventors: Nicholas Oliver Nugent, Hampshire (GB); Dennis James Warwick, Richfield, MN (US); Brian Beech, Bloomington, MN (US)

(21) Appl. No.: 14/414,302

(22) PCT Filed: Jul. 12, 2012
(86) PCT No.: PCT/US2012/046376

§ 371 Date: Jan. 12, 2015

(51) Int. Cl. B42D 25/309; B42D 25/475; B23K 26/36; B42D 25/324

(52) U.S. Cl. CPC B42D 25/309; B42D 25/324; B42D 25/475; B23K 26/365; B42D 2033/04; B42D 2033/10; B42D 2035/06; B42D 2035/30

(57) ABSTRACT

A security feature is formed in a window region in which an ablatable foil element is disposed. The security feature can be a portrait image of the intended holder of the identification document or any other personal data of the intended holder. The security feature is added to the foil element at the time of personalization of the document using a laser to ablate (i.e. remove) metal from the foil. The resulting security feature can be transparent. In addition, a variable data security feature is provided that extends across the boundary between the window region and the remainder of the card body.

### FIELD

This disclosure relates to security features useable on identification documents, such as plastic and composite cards including identification cards, credit and debit cards, and the like, as well as passports. More particularly, this disclosure relates to a security feature formed in an ablated foil element in an identification document.

### BACKGROUND

Identification documents such as identification cards, credit and debit cards, and the like, and passports, are personalized with information concerning the intended holder of the identification document and then issued to the intended holder. Personalization and issuance are typically handled by government agencies, credit card companies, or other entities authorized to handle the personalization and issuance process.

As part of the personalization and issuance process, the identification documents can undergo a number of personalization procedures, including printing, portrait printing, magnetic stripe and/or chip encoding, embossing, lamination of protective laminates, and other known procedures.

A number of security measures have been implemented in order to resist counterfeiting, forgery or tampering with identification documents. An example of a previous security feature that is ablated into a foil is disclosed in U.S. Patent Application Publication US 2011/0037247.

Further improvements to security measures to resist counterfeiting, forgery or tampering with identification documents, as well as resist fraudulent use of identification documents once issued, are needed.

### SUMMARY

Security features are described that are useable on identification documents including identification cards, driver's licenses, credit and debit cards, and the like, as well as passports, to resist counterfeiting, forgery or tampering with the document, and yet are easy to verify. If an attempt is made to alter the document, defects will show that can be easily recognized when the document is presented at a point of inspection.

A security feature that is added at the time of personalization of the identification document is preferred, since this allows use of personal data in the security feature(s) to reduce the chance of mass counterfeiting. In addition, anti-tamper security can be readily added at that time, and the value to a criminal of stolen “blank” documents is reduced.

In one embodiment, a security feature is formed in a window region of the identification document in which an ablatable foil element is disposed. The security feature can be a portrait image of the intended holder of the identification document or any other personal data of the intended holder. The security feature is added to the foil element at the time of personalization of the document using a laser to ablate (i.e. remove) material, such as metal in the case of a metalized foil, from the foil. If the foil is non-metallic, then opaque, non-metallic material is ablated from the foil. Ablation of the material reveals a transparent layer on which the ablated material was initially deposited.

In one embodiment, the resulting security feature can be referred to as a positive security feature, where the security feature is formed at the locations where material is ablated and the resulting security feature is transparent. In this embodiment, because metal or other material is removed from the foil and the security is formed at the locations where the material is removed, the security feature defends against the fraudulent addition of information to the security feature, such as adding longer hair, glasses, a beard, etc. in the case of a photograph.

In another embodiment, the resulting security feature can be referred to as a negative security feature, where the security feature is formed by ablating material surrounding the security feature and the security feature is formed by non-ablated material that remains behind. In this embodiment, the security feature is not transparent at the locations where the non-ablated material remains.

The security feature in the window region can be enhanced by the addition of a variable data security feature that extends across the boundary between the window region and the remainder of the document body. The variable data security feature is unique to the identification document since it is formed from personal data of the intended holder. In one embodiment, the variable data security feature is formed on the document body, for example by laser engraving or printing on one side of the boundary, and in the foil element in the window region on the other side of the boundary, for example by laser ablation of the foil element. However, any personalization process or combination of processes can be used to form the variable data security feature on each side of the boundary. For example, the variable data security feature could be indented or embossed on each side of the boundary, laser engraved and printed, printed and laser ablated, etc.

Within the window region, the variable data security feature can be formed at locations where material has been ablated from the foil, and the variable data security feature is transparent surrounded by regions of non-ablated material of the foil. Alternatively, material can be ablated from the foil leaving behind non-ablated areas that form the variable data security feature, so that the variable data security feature is not transparent and surrounded by transparent regions where material has been ablated from the foil.

In another embodiment, the window region has a perimeter that is shaped in the form of a territorial boundary of a country, region, territory, state, city, or that is shaped in the form of a logo representing a governmental entity or a company. In other words, the perimeter of the window region has an irregular shape. The irregular shaped window region can be formed by the printing process that is used to create the base color of the document.

In one embodiment, a territorial boundary or a logo can also be ablated into the foil element, for example surrounding the portrait image of the intended holder of the identification document that also has been ablated into the foil element. The ablated territorial boundary or logo can be disposed within the corresponding shaped irregular shaped window region. Alternatively, a territorial boundary or a logo can be ablated into the foil next to, but separate from, any other security feature ablated into the foil, or the ablated security features could overlap, etc. In addition, a territorial boundary or a logo can be ablated into a foil element in a separate window on the identification document.

As used herein, ablating a security feature (whether a portrait image, a variable data security feature, a territorial boundary or logo, or other) into a foil element is intended to encompass instances where the security feature is formed at locations where material has been ablated from the foil element, and the variable data security feature is transparent surrounded by regions of non-transparent, non-ablated material of the foil element. Ablating a security feature into a foil element also encompasses instances where material is ablated from the foil element leaving behind non-ablated areas that form the security feature, so that the security feature is not transparent but is instead surrounded by transparent regions where material has been ablated from the foil element.

In one embodiment, an identification document includes a document body having a window region in which an ablatable foil element is disposed, and a portrait image of the intended holder of the identification document ablated into the foil element in the window region. The portrait image can be transparent surrounded by non-ablated material of the foil element, or the portrait image can be non-transparent and formed by non-ablated material of the foil element, and surrounded by transparent areas of the foil element where material has been ablated. The document body further includes a portrait image of the intended holder of the identification document outside of the window area. Also, a variable data security feature that is unique to the identification document extends across the boundary between the window region and the rest of the document body. The variable data security feature is formed on the document body and ablated into the foil element in the window region.

The foil element can be a metallic foil or a non-metallic foil. In each case, at locations where the material of the foil is ablated or removed by the laser, a transparent layer on which the ablated material was initially deposited is revealed. This renders the window region see-through in the locations where the material has been removed, if the layers of the card body beneath the window region are transparent or translucent.

In one embodiment, the variable data security feature can be laser engraved on the document body or printed on the document body, and the variable data security feature in the window region can be ablated within the foil element using a laser. However, other personalization processes or combination of processes, such as indenting or embossing, laser engraving and printing, printing and laser ablating, can be used to form the variable data security feature on each side of the boundary.

The variable data security feature preferably comprises variable data of the intended holder of the identification document. Examples of variable data include, but are not limited to, some portion or all of the holder's portrait image, name, birth date, social security number, a signature, an address, an assigned account number, and any combination thereof. The variable data security feature can extend partially into and end in the window region, the feature can extend across the window region so that it crosses two or more boundaries, the feature can cross the same boundary twice or more, the variable data security feature can intersect the ablated portrait image or be separate from the ablated portrait image, and many other configurations, sizes and shapes of the variable data security feature are possible. In an embodiment, the variable data security feature is formed by microengraving and microablating variable text data where the text is too small to be read with the naked eye but can be read using an optical magnifier. However, the text could be made so that it can be read with the naked eye without magnification.

To enhance security, other security features can be incorporated into the identification document separately from or in addition to the variable data security feature. For example, the window region can have a perimeter that is shaped in the form of a territorial boundary of a country, region, territory, state, city, or that is shaped in the form of a logo representing a governmental entity or a company. In another example, a plurality of window regions can be provided in the document body, with each window region including an ablatable foil element, and a security feature of some form is ablated into the foil element in each window area. In another example, an optically variable device (OVD), such as a diffractive optically variable device (DOVD), is disposed within or over the window region, for example over the ablated portrait image of the intended holder of the identification document.

The identification document can be any type of document where resistance to counterfeiting and fraudulent alteration are important. For example, the identification document can be a card or a passport. The card can be predominantly formed from a single type of plastic material (for example polycarbonate, polyvinyl chloride, polyethylene terephthalate or the like) or it can be formed from multiple different types of plastic material. Specific examples of cards include, but are not limited to, national identification cards, driver's licenses, health care identification cards, and credit or debit cards. With respect to passports and other travel documents, the security features described herein can be employed on the polycarbonate datapage(s).

One embodiment of a method of forming the identification document includes forming the variable data security feature so that the variable data security feature extends from outside the window region of the document body into the window region, the variable data security feature is formed on the document body and ablated into the foil element in the window region. For example, the variable data security feature can be laser engraved or printed on the card body outside the window region, while a laser is used to ablate the variable data security feature on the foil element in the window region. One advantage of using a single technology, such as a laser, to produce the continuous security feature across the window boundary is that inspection would reveal if a simulation of the security feature had been produced using alternative personalization technologies.

### DRAWINGS

FIG. 1 is a view of the front side of an identification document that includes an ablated security feature in a window together with a variable data security feature extending into the window.

FIG. 2 is a close-up view of the area within circle 2 in FIG. 1 showing details of the variable data security feature at the boundary between the window and the document body.

FIG. 3 is a view of the front side of an identification document that is similar to FIG. 1 but showing additional security features, including an irregular shaped window, that can be incorporated on the identification document.

FIG. 4 is a cross-sectional view of the identification document taken along line 4-4 of FIG. 1.

FIG. 5 is a cross-sectional view similar to FIG. 4 but showing an alternative construction of an identification document.

### DETAILED DESCRIPTION

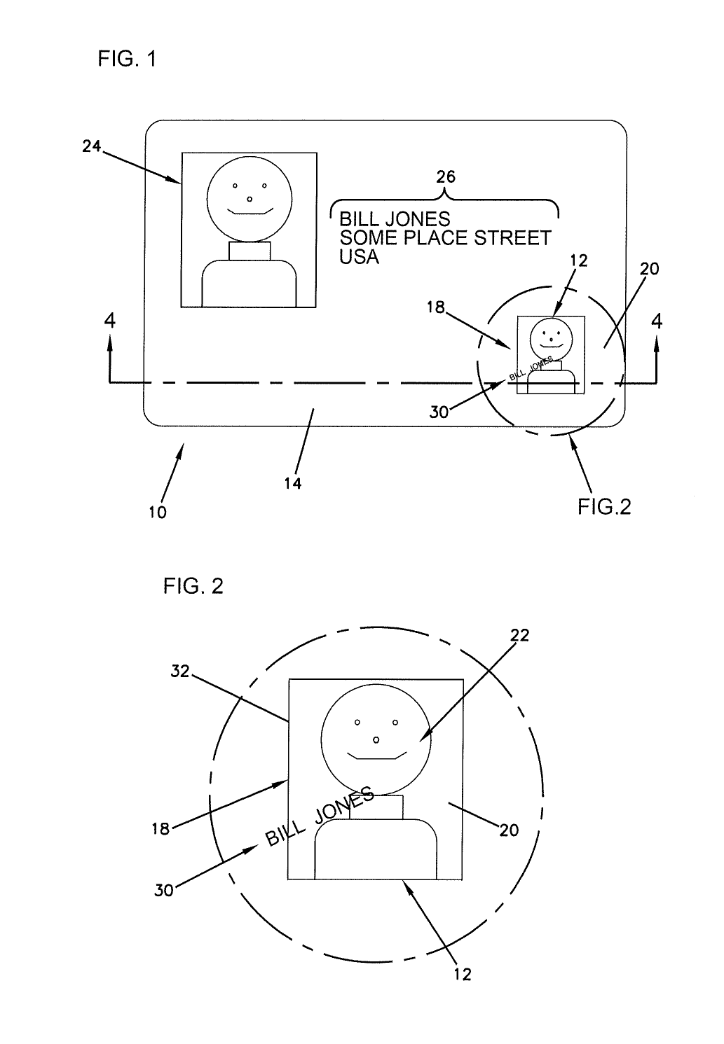

FIG. 1 illustrates an identification document 10 with an ablated security feature 12. The identification document 10 can be any identification document that has personalization for example a portrait image or other personal information. Examples of identification documents on which the security feature can be used include but are not limited to cards formed predominantly from a single type of plastic (e.g. PVC, PET, polycarbonate) or cards formed from different types of plastics, for example identification cards, credit and debit cards, and the like, as well as passports.

The document 10 is formed by a document body 14 having a window region 18 in which an ablatable foil element 20 is disposed. Various configurations of the foil element 20 are possible as discussed below in FIGS. 4-5. The foil element 20 can be a metallic foil or a non-metallic foil. In each case, the foil element has an ablatable material that is deposited onto a transparent layer. When the ablatable material is removed, the transparent layer is revealed.

A portrait image 22 of the intended holder of the identification document is ablated into the foil element in the window region. In the illustrated embodiment, the resulting ablated portrait image 22 is transparent. The document body 14 also includes a portrait image 24 of the intended holder of the identification document outside of the window region 18. The portrait image 24 can be applied using known techniques. Additional personal data 26 for example, but not limited to, the document holder's name, a unique identifier such as an account or serial number, birthdate, or signature, or general information such as citizenship, can also be provided on the document body 14 using known techniques.

As described further in US 2011/0037247, the ablated portrait image 22 of the document holder is transparent, allowing one to see through the entire document. The ablation is achieved using a laser that removes material, such as metal, from the foil at the locations corresponding to the photograph. Where the material is removed, the remaining foil that is revealed is transparent. Because material is removed from the foil, the ablated portrait image 22 defends against the fraudulent addition of information to the portrait image 22, such as adding longer hair, glasses, a beard, etc.

However, the ablated portrait image 22 can be non-transparent and formed by non-ablated areas surrounded by transparent regions where material has been ablated from the foil element.

Hereinafter, the portrait image 22 and other security features discussed below will be described as being an ablated security feature or ablated into the foil element. This language is intended to encompass instances where the security feature is formed at locations where material has been ablated from the foil element, and the security feature is transparent surrounded by regions of non-transparent, non-ablated material of the foil element, and also encompass instances where material is ablated from the foil element leaving behind non-ablated areas that form the security feature, so that the security feature is not transparent but is instead surrounded by transparent regions where material has been ablated from the foil element.

To further enhance security, a variable data security feature 30 that is unique to the identification document 10 is added. As best seen in FIG. 2, the variable data security feature 30 extends continuously from the document body 14 across the boundary 32 between the document body and the window region 18 and into the window region 18. Therefore, the variable data security feature 30 is formed both on the document body 14 and in the window region 18.

The variable data security feature 30 is unique to the identification document 10 since it is formed from variable data of the intended holder. In the illustrated embodiment, the variable data security feature 30 is the name of the intended holder of the identification document. However, the variable data can be any variable data personal to or uniquely assigned to the intended holder of the identification document. Examples of variable data include, but are not limited to, some portion or all of the holder's photograph, name, birth date, social security number, a signature, an address, an assigned account number, and any combination thereof.

In the illustrated embodiment, the variable data security feature 30 extends from the card body 14, across the boundary 32, and partially into and ends in the window region 18. However, the variable data security feature 30 can extend across the window region 18 so that it crosses two or more boundaries 32 of the window region, the variable data security feature can cross the same boundary 32 twice or more, the variable data security feature can intersect the ablated photograph 22 or be separate from the photograph 22, and many other configurations, sizes and shapes of the variable data security feature are possible.

The text forming the variable data security feature 30 can be micro in size where the text is too small to be read with the naked eye but can be read using an optical magnifier. Alternatively, the text can be large enough to be read with the naked eye, or a combination of large enough to be read with the naked eye and micro text.

The variable data security feature 30 is formed on the document body 14, for example a laser or printing on one side of the boundary 32, and is also formed on the foil element 20 in the window region 18 on the other side of the boundary 32, for example by being laser ablated into the foil element.

In one embodiment, a single laser can be used for creating the variable data security feature 30. For example, the laser can be used to laser engrave the portion of the variable data security feature 30 present on the document body 14 in a manner known in the art. However, the laser continues across the boundary 32 for use in ablating the foil to create the portion of the variable data security feature that is formed on the foil element 20. Thus, in this example, one portion of the variable data security feature is formed by laser engraving while another portion of the variable data security feature is formed by an ablated portion of the foil element. If appropriate, the laser can continue across the window and across another boundary or the same boundary it initially crossed and back into the document body 14, to continue formation of the variable data security feature. If it is determined to be necessary, the power level of the laser as well as the focal point of the laser can be changed as the laser transitions between the boundary to ensure proper laser engraving and laser ablation.

Although the variable data security feature has been described as being formed using a laser, any personalization process or combination of personalization processes can be used to form the variable data security feature on each side of the boundary 32. For example, the variable data security feature could be indented or embossed on each side of the boundary, laser engraved in the document body and printed on the foil element, printed on the document body and laser ablated on the foil element, etc. Therefore, the variable data security feature can have one portion in the document body formed by a first type of personalization process, and a second portion on the foil element formed by a second type of personalization process different than the first type of personalization process.

Turning to FIG. 4, an exemplary construction of the identification document 10 in the form of a plastic card is illustrated. In this construction, the card includes a foil layer 50 that can be a metallic foil or a non-metallic foil. A suitable metalized foil is available from Crown Roll Leaf, Inc. of Paterson, N.J. Where a laser is applied to the foil layer, the metal is removed, revealing a transparent layer on which the metal was initially deposited. Overlays 52, 54 are disposed on each side of the foil layer 50. The overlays 52, 54 can be any material suitable for forming a card or other identification document, for example PVC, PET, or polycarbonate. The overlays 52, 54 are transparent at least in the window region(s), although the overlays can also be provided with colors, patterns, holographic features, etc.

One or more layers 56 of ink are printed onto the overlay 52 to form the base color, for example white, of the document. The ink layer 56 can be applied using a suitable technique such as lithographic or screen printing. However, ink is not printed where the window region 18 is to be formed. Therefore, since printing is used to apply the ink layer 56, the boundary of the window region(s) 18 as well as the location(s) on the document can be precisely controlled. Similarly, one or more layers 58 of ink are printed onto the outer surface of the overlay 54 to help form the base color, for example white, of the document 10 using the same or different printing technique as the ink layer 56.

After the layers 56, 58 are printed, protective overlays 60, 62 are applied to the top and the bottom. The overlays are transparent, although the overlays can also be provided with colors, patterns, holographic features, etc.

If necessary, security printing can be printed on one or more of the ink layers 56, 58, and/or security printing can be applied to the overlays 60, 62 or provided on non-illustrated layers over the ink layers 56, 58.

Many other constructions of the document 10 are possible. FIG. 5 illustrates another embodiment where the foil layer 50 of FIG. 4 is replaced with an ablatable foil patch 70 that has a size that is generally slightly larger than the intended window region. The patch 70 is disposed between two layers of film 72, 74 that are similar to the overlays 52, 54. Ink layers 76, 78 are printed on the outside of the films 72, 74 similarly to FIG. 4 to form the base color of the document. After printing the ink layers, protective overlays 80, 82, similar to the overlays 60, 62, are applied to the top and the bottom of the document. This construction reduces the amount of foil that is used and improves the construction of the document 10 since a high quality bond between the overlays 52, 54 and the foil 50 in FIG. 4 can be difficult to achieve.

Regardless of the specific document construction that is used, the use of printing on the layers 52, 54, 72, 74 to form the base color of the document provides flexibility in the size, shape and location of the window region(s) 18 on the document by controlling the printing process that applies the ink layers. A window region can be formed at any location on the document through suitable control of the printing process. Therefore, a single window region or multiple window regions can be formed on the document.

In addition, the window region can be formed to have a regular shape, for example circular, rectangular, triangular, etc., or formed to have an irregular shape. An irregular shape permits the formation of uniquely shaped windows that may be requested by customers. For example, the window region can be formed to have an irregular perimeter that is shaped in the form of a territorial boundary of a country, region, territory, state, city, or that is shaped in the form of a logo representing a governmental entity or a company.

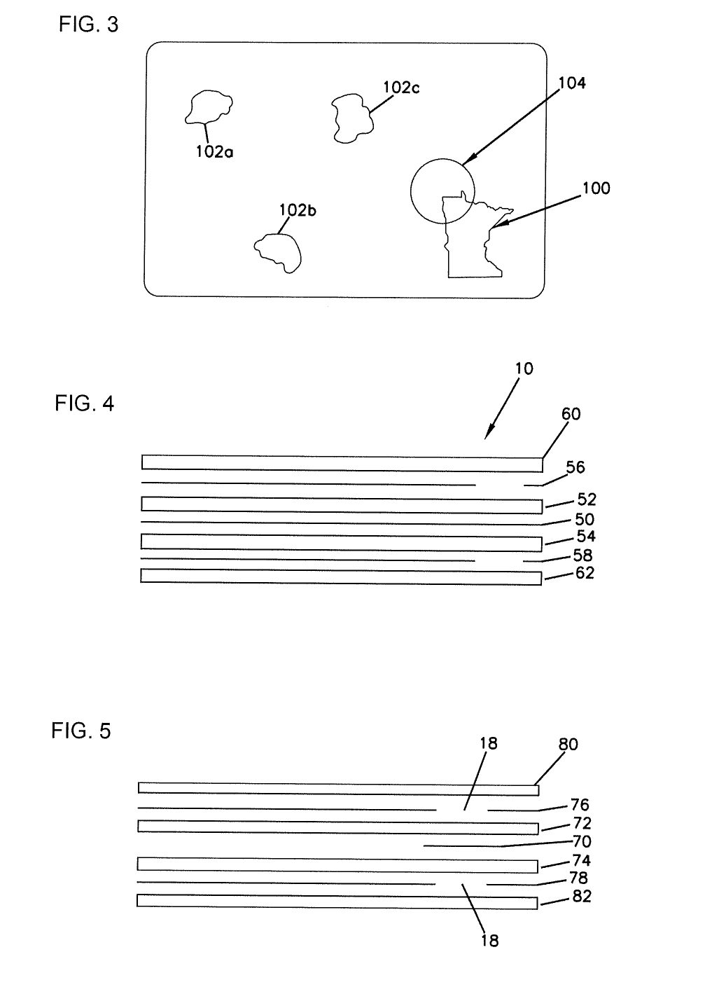

An example of an irregular window is shown in FIG. 3, where a window 100 is formed in the shape of the State of Minnesota. While the shape of the window 100 and the ability to form irregular window shapes is unique, the ablated portrait image 22 can optionally be formed within the window 100, and optionally the variable data security feature 30 can be provided as well.

Optionally, an OVD 104, for example a DOVD such as a hologram or a printed optically variable device, can be used to further enhance security. The OVD can be formed either within the foil of the window area and/or formed within an overlay that lies over the window region so that the OVD is disposed within the window region. For example, the OVD can be formed in an overlay so that the OVD lies over the window region, for example the window region 100 as illustrated in FIG. 3 or over the window region 18 in FIG. 1. The OVD can be positioned so that it is disposed over at least a portion of the ablated portrait image of the intended holder of the identification document in the window region. The OVD 104 can be provided in any suitable manner, for example on the protective overlay 60, 80 or the OVD can be in the form of a patch that is positioned between the protective overlay 60, 80 and the ink layer 56, 76. Alternatively, the OVD can be formed within the foil 50, 70 of the window area. Any means of providing the OVD as long as the OVD is disposed within the window region can be used.

FIG. 3 also shows additional windows 102a, 102b, 102c formed in the document. If the foil layer 50 is used, a security feature can be formed in each of the windows 102a-c if desired by ablating the foil. Alternatively, an ablatable foil patch can underlie each window 102a-c to allow ablation of a security feature into each window.

Many options are available for added security features in the window region. In the case of metallized foils, most metallized foils are metallized using aluminum so that the unablated portions of the foil in the window region have the color of aluminum. However, other metallized foils can be used to change the color appearing in the window. For example, copper, gold, other metals and mixtures of metals can be used to metallize the foil to help change the color in the window region. In addition, various color tints can be added to the foil layer, to the overlays 52, 54, to the overlays 60, 62, or anywhere else in the window region(s), or colored overlays can be provided in the window region(s), to provide a desired color appearance.

In addition, one or more security holographic devices, registered and unregistered, can be provided in the window region. The holographic device can be, for example, a hologram or a printed optically variable device, provided in or on any layer within the window region.

In addition, an additional holographic overlay or laminate can be added as the top layer of the document construction (i.e. over layer 60 in FIG. 4 or over layer 80 in FIG. 5).

The embodiments disclosed in this application are to be considered in all respects as illustrative and not limitative. The scope of the claimed invention is indicated by the appended claims rather than by the foregoing description; and all changes which come within the meaning and range of equivalency of the claims are intended to be embraced therein.

1-18. (canceled)

19. An identification document comprising a document body having a transparent window region in which an ablatable foil element is disposed; a portrait image of the intended holder of the identification document ablated on the foil element in the window region; the document body includes a portrait image of the intended holder of the identification document outside of the window region; and a variable data security feature that is unique to the identification document that extends from the document body and into the transparent window region, the variable data security feature is formed on the document body and is ablated on the foil element in the transparent window region.

20. The identification document of claim 19, wherein the foil element is a metallic foil or a non-metallic foil.

21. The identification document of claim 19, wherein the variable data security feature is laser engraved on the card body or printed on the card body, and the variable data security feature in the transparent window region is ablated on the foil element using a laser.

22. The identification document of claim 19, wherein the variable data security feature comprises variable data of the intended holder of the identification document.

23. The identification document of claim 19, wherein the transparent window region has a perimeter that is shaped in the form of a territorial boundary of a country, region, territory, state, city, or that is shaped in the form of a logo representing a governmental entity or a company.

24. The identification document of claim 19, further comprising a plurality of transparent window regions in the document body, each transparent window region including an ablatable foil element, and a security feature ablated on the foil element in each transparent window area.

25. The identification document of claim 19, further comprising a diffractive optically variable device disposed within the transparent window region.

26. The identification document of claim 25, wherein the diffractive optically variable device is disposed over the ablated portrait image of the intended holder of the identification document.

27. The identification document of claim 19, wherein the ablated portrait image and the ablated variable data security feature are transparent.

28. The identification document of claim 19, comprising at least one of the following:
the foil element is a metallic foil coated with aluminum, gold, copper or mixtures thereof;
a colored overlay disposed in the transparent window region;
a security holographic device in the transparent window region;
an optically variable device in the transparent window region; and
a holographic top layer on the identification document.

29. The identification document 19, wherein the identification document is a card or a passport.

30. The identification document of claim 19, wherein the foil element is a patch.

31. The identification document of claim 19, wherein the variable data security feature is formed in the document body other than the foil element outside of the transparent window region.

32. An identification document comprising a document body having a transparent window region in which an ablatable foil element is disposed; a portrait image of the intended holder of the identification document ablated into the foil element in the transparent window region; the document body includes a portrait image of the intended holder of the identification document outside of the transparent window region; and the transparent window region has a perimeter that is irregularly shaped.

33. The identification document of claim 32, wherein the transparent window region has a perimeter that is shaped in the form of a territorial boundary of a country, region, territory, state, city, or that is shaped in the form of a logo representing a governmental entity or a company.

34. The identification document 32, wherein the identification document is a card or a passport.

35. The identification document of claim 32, wherein the foil element is a patch

36. The identification document of claim 32, wherein the variable data security feature is formed in the document body other than the foil element outside of the transparent window region.

37. A method of forming an identification document, comprising:
forming a portrait image of the intended holder of the identification document on a document body outside of a transparent window region of the document body;
ablating a portrait image of the intended holder of the identification document in a foil element in the transparent window region of the document body; and
forming a variable data security feature that is unique to the identification document on the document body so that the variable data security feature extends from outside the transparent window region of the document body into the transparent window region, the variable data security feature is formed on the document body and formed in the foil element in the transparent window region.

38. The method of claim 37, comprising laser engraving or printing the variable data security feature on the card body outside the transparent window region, and using a laser to ablate the variable data security feature on the foil element in the transparent window region.

39. The method of claim 37, comprising forming the transparent window region so that it has a perimeter that is shaped in the form of a territorial boundary of a country, region, territory, state, city, or that is shaped in the form of a logo representing a governmental entity or a company.

40. The method of claim 37, further comprising forming a plurality of transparent window regions in the document body, each transparent window region including an ablatable foil element, and ablating a security feature into the foil element in each transparent window area.

41. The method of claim 37, further comprising disposing a diffractive optically variable device within the transparent window region.

42. The method of claim 41, comprising locating the diffractive optically variable device so that once the ablated portrait image of the intended holder of the identification document is formed, the diffractive optically variable device overlies the ablated portrait image.

43. The method of claim 37, outside of the transparent window region, forming the variable data security feature in the document body other than the foil element.
